(19) United States
(12) Patent Application Publication
(10) Pub. No.: US 2016/0358114 A1
(43) Pub. Date: Dec. 8, 2016

(54) PRESENTATION OF BUSINESS AND PERSONAL PERFORMANCE QUANTIFIERS OF A USER

(71) Applicant: Avaya Inc., Santa Clara, CA (US)

(72) Inventors: John H. Yoakum, Cary, NC (US); Tony McCormack, Barna (IE); Cynthia S. Mitchell, Windsor, CO (US)

(21) Appl. No.: 14/729,502

(22) Filed: Jun. 3, 2015

(51) Int. Cl. G06Q 10/06

(52) U.S. Cl. CPC G06Q 10/06395

(57) ABSTRACT

The embodiments relate to the presentation of business and personal performance quantifiers of a user in association with each other. In a non-limiting embodiment, the business and personal performance quantifiers of the user are presented relative to a particular period of time. The embodiments allow the user to assess if a cause-effect relationship exists between the business and personal performance quantifiers. As a result, the user may modify a personal and/or a business activity in order to improve a personal and/or business performance. A method provided includes a personal computing device receiving, over a first period of time, business activity performance quantifiers, receiving, over the first period of time, personal activity quantifiers of the user, generating a dashboard view comprising a visual representation of the business activity performance quantifiers and the personal activity quantifiers relative to the first period of time, and presenting the dashboard view on a display device.

### TECHNICAL FIELD

The disclosure relates generally to presenting performance metrics of a user and, in particular, to generating and presenting business activity performance metrics of the user in association with personal activity metrics of the user.

### BACKGROUND

Business activity performance metrics relate to the measurement of activities performed by an organization. In particular, an organization establishes a business objective, identifies specific and quantifiable outputs of work necessary to achieve the business objective, and quantifies the outputs of work to, for example, assess progress towards meeting the business objective and/or improve processes for meeting future business objectives. Business activity performance metrics may measure performance at the organization level and/or at the individual level.

Advances in computing and sensing technology have made it possible for individuals to track metrics related to, for example, fitness and health activities. In particular, an individual may wear a device like, for example, a bracelet, that measures fitness and health metrics such as, for example, heart rate, blood pressure, and body temperature. Analysis of these measurements may help the individual assess and/or improve his or her fitness and/or health.

### SUMMARY

The embodiments relate to the presentation of business and personal performance quantifiers of a user in association with each other. In a non-limiting embodiment, the business and personal performance quantifiers of the user are presented relative to a particular period of time. Among other advantages, the embodiments allow the user to assess if a cause-effect relationship exists between the business and personal performance quantifiers. As a result, the user may modify a personal activity and/or a business activity in order to improve a personal performance and/or a business performance.

In that regard, in one embodiment, a method for providing information to a user is provided. The method includes receiving, over a first period of time by a personal computing device, a first plurality of business activity performance quantifiers that quantify at least one business activity performance metric of the user over the first period of time, and receiving, over the first period of time by the personal computing device, a first plurality of personal activity quantifiers of the user that quantify at least one personal activity metric of the user over the first period of time. The method further includes generating, by the computing device, a dashboard view comprising a visual representation of the first plurality of business activity performance quantifiers and the first plurality of personal activity quantifiers relative to the first period of time, and presenting, by the personal computing device, the dashboard view on a display device. This allows the user to track business activity performance metrics and personal activity metrics, relative to the first period of time, determine if a cause-effect relationship exists, and/or observe if a correlation exists.

In another embodiment, a computer device is provided. The computer device includes a communication interface configured to communicate with a network, and a processor, coupled to the communication interface. The processor is configured to receive, over a first period of time, a first plurality of business activity performance quantifiers that quantify at least one business activity performance metric of the user over the first period of time, and receive, over the first period of time, a first plurality of personal activity quantifiers of the user that quantify at least one personal activity metric of the user over the first period of time. The processor is further configured to generate a dashboard view comprising a visual representation of the first plurality of business activity performance quantifiers and the first plurality of personal activity quantifiers relative to the first period of time, and present the dashboard view on a display device.

In another embodiment, a computer program product for providing information to a user is provided. The computer program product is stored on a non-transitory computer-readable storage medium and includes instructions configured to cause a processor to carry out a plurality of steps. The computer program product causes the processor to receive, over a first period of time, a first plurality of business activity performance quantifiers that quantify at least one business activity performance metric of the user over the first period of time, and receive, over the first period of time, a first plurality of personal activity quantifiers of the user that quantify at least one personal activity metric of the user over the first period of time. The computer program product further causes the processor to generate a dashboard view comprising a visual representation of the first plurality of business activity performance quantifiers and the first plurality of personal activity quantifiers relative to the first period of time, and present the dashboard view on a display device.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a block diagram of a system in which embodiments may be practiced;

FIG. 2 is a flowchart of a method for providing information to a user according to one embodiment;

FIG. 3 is a message flow diagram illustrating an example flow of communications in the system according to one embodiment;

FIG. 4A illustrates a format of a business activity performance quantifier message according to one embodiment;

FIG. 4B illustrates an example content for a business activity performance quantifier message according to one embodiment;

FIG. 5A illustrates a format of a personal activity quantifier message according to one embodiment;

FIG. 5B illustrates an example content for a Personal Activity Quantifier Message according to one embodiment;

FIG. 6 illustrates a dashboard view including a visual representation of business activity performance quantifiers and personal activity quantifiers relative to a time period according to one embodiment;

FIG. 7 is a flowchart of a method for providing an alert to a user according to one embodiment; and

FIG. 8 is a block diagram of a computing device according to one embodiment.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first period of time” and “second period of time,” and does not imply a priority, a type, an importance, or other attribute, unless otherwise stated herein.

The embodiments relate to the presentation of business and personal performance quantifiers of a user in association with each other. In a non-limiting embodiment, the business and personal performance quantifiers of the user are presented relative to a particular period of time. Among other advantages, the embodiments allow the user to assess if a cause-effect relationship exists between the business and personal performance quantifiers. As a result, the user may modify a personal activity and/or a business activity in order to improve a personal performance and/or a business performance.

The phrase “business activity performance quantifiers” as used herein is data representative of performance of a user with respect to business-related activities. The data may be captured during a particular period of time and may be provided relative to the period of time. As a non-limiting example, in a contact center scenario, a business activity performance quantifier may represent how many calls the user has received, how many calls the user has attended to successfully, how many calls the user has failed to attend to successfully, or how much time the user is spending per call. These or similar quantifiers may be provided relative to the period of time without departing from the spirit and scope of the disclosure.

The phrase “personal activity quantifiers” as used herein is data representative of physical, personal, and/or health activities of the user. The data may be captured during a particular period of time and may be provided relative to the period of time. As a non-limiting example, personal activity quantifiers may represent a heart rate, a blood pressure, a body temperature, an amount of sleep within an earlier period of time, an amount of alcohol consumed over another earlier period of time, and a type and potential duration of physical activity (e.g., walking, running, being stationary, etc.). These or similar quantifiers may be provided relative to the period of time, or may be provided relative to a separate period of time, without departing from the spirit and scope of the disclosure.

The phrase “business activity performance metric” as used herein is a type of business activity quantified by business activity performance quantifiers. As a non-limiting example, in a contact center environment, a business activity performance metric may include a number of calls a user has received during a period of time (e.g. calls received per hour), whereas a business activity performance quantifier corresponding to the business activity performance metric would be a value that identifies a number of calls that the corresponding user has received during the particular period of time. In a contact center environment, business activity performance metrics may also include calls completed per hour, and average time per completed call.

The phrase “personal activity metric” as used herein is a type of personal activity quantified by personal activity quantifiers. As a non-limiting example, a “heart rate” metric is a personal activity metric, whereas a personal activity quantifier corresponding to the heart rate metric would be a value that identifies the heart rate of a particular user. Personal activity metrics may also include, by way of non-limiting example, blood pressure and body temperature.

The phrase “lag time” as used herein is a value of time representative of a lag between the end of a personal activity and when such personal activity may still cause an effect. As a non-limiting example, consumption of alcohol may decrease a business activity performance for 3 hours after the alcohol is consumed, and thus, a personal activity metric type regarding alcohol consumption may have an associated lag time of 3 hours.

The term “correlation” as used herein relates to the strength of a relationship between two continuous variables. The phrase “correlation coefficient” as used herein relates to a value representing the strength of a relationship between two continuous variables. Methods to determine a correlation between two continuous variables are further described in the article “Correlation and Simple Linear Regression,” by Zou, et al., Radiology 2003; 227:617-622, published online as http://dx.doi.org/10.1148/radiol.2273011499 (“Zou” hereinafter), which is incorporated herein in its entirety. Those skilled in the art will understand that the methods and concepts described in Zou are non-limiting, and that a correlation between two or more variables may be determined in other ways.

The embodiments implement a computing device that receives business activity performance quantifiers associated with a business activity performance metric of a user and personal activity quantifiers associated with a personal activity metric of the user. The quantifiers are measurements obtained relative to a period of time. The computing device generates a dashboard view that includes a visual representation of the received quantifiers in association with the period of time and presents the dashboard view to the user on a display device. The dashboard view may also include a visual representation of a correlation between the received quantifiers in association with the period of time. Thus, the embodiments provide to the user a visual representation of his or her performance and, specifically, how personal activities may be having an effect on the business activities of the user.

The embodiments have applicability in many different contexts, including, by way of non-limiting example, a contact center (e.g., customer service or sales). In this context, a contact center employee may own or otherwise exclusively control a personal computing device and a personal wearable device. The personal computing device may include, as non-limiting examples, a personal smartphone or a computer tablet. The personal wearable device may include, as a non-limiting example, a wearable device configured to provide health and/or fitness information, such as heart rate information and body temperature information of a corresponding user. In one embodiment, the employee may receive at the personal computing device business activity performance quantifiers from, for example, a business server computing device, and personal activity quantifiers from the personal wearable device. The personal computing device may generate and present a visual representation of the quantifiers relative to a time period, which may provide the user insight as to the relationship between his or her business performance and personal activities.

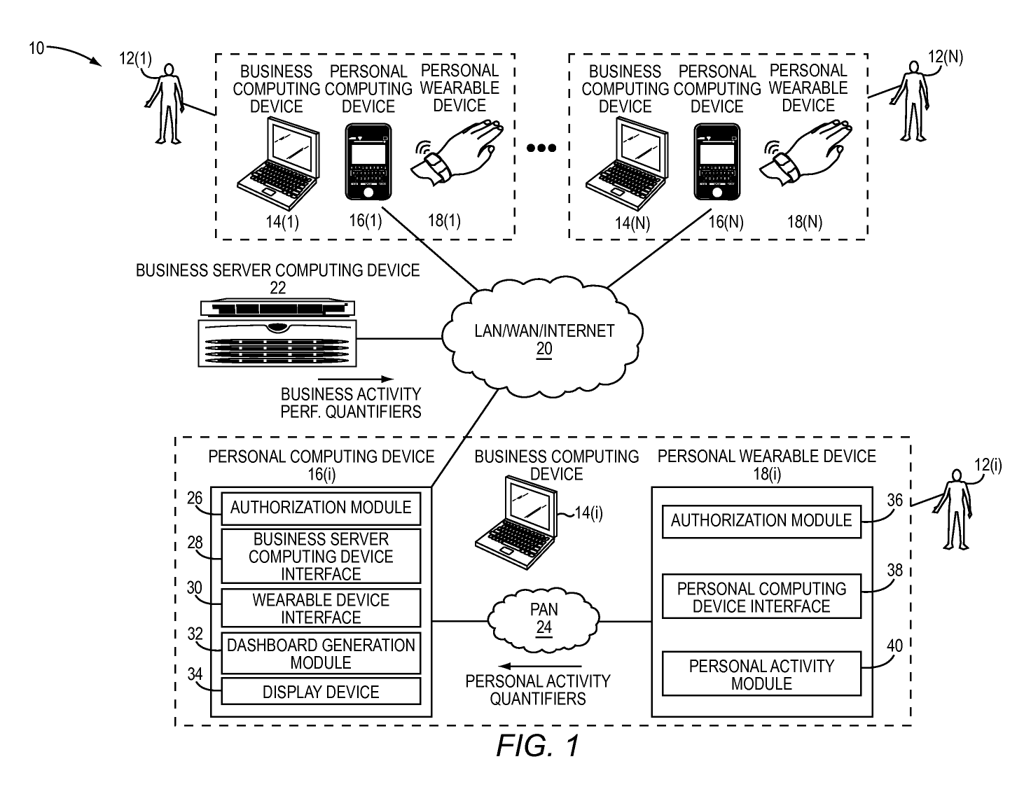

In this regard, FIG. 1 is a block diagram of a system 10 in which embodiments may be practiced. The system 10 includes a plurality of users 12(1)-12(n) and 12(i) (generally, users 12), each of users 12 having access to a corresponding business computing device 14(1)-14(n) and 14(i) (generally, business computing devices 14), a corresponding personal computing device 16(1)-16(n) and 16(i) (generally, personal computing devices 16), and a corresponding personal wearable device 18(1)-18(n) and 18(i) (generally, personal wearable devices 18). Each of the business computing devices 14 is communicatively coupled to a local area network (LAN), wide area network (WAN), or Internet network 20, and may be used by a corresponding user 12 to perform business-related tasks. In some embodiments, each business computing device 14 may only be accessed by the corresponding user 12 and by a corresponding employer/business entity. In some embodiments, each business computing device 14 may also be accessed by one or more additional users 12.

The personal computing devices 16 may be communicatively coupled to the LAN/WAN/Internet network 20 and may be used by a corresponding user 12 to access information from a networked device of the employer, such as from a business server computing device 22, through the LAN/WAN/Internet network 20. In some embodiments, each personal computing device 16 may also be used by the corresponding user 12 to perform business-related tasks.

Contrary to the configuration of the business computing devices 14, each of the personal computing devices 16 is configured to be exclusively accessed by the corresponding user 12. In some embodiments, this access may be controlled through a login name/password validation or biometric data validation (e.g., fingerprint, retina scan, etc.). Accordingly, information in each of the personal computing devices 16 is exclusively accessed and controlled by the corresponding user 12. As will be explained in further detail below, each of the personal computing devices 16 may also be communicatively coupled to a corresponding personal area network (PAN) to communicate with a corresponding personal wearable device 18.

A personal wearable device 18 is worn by a corresponding user 12 to measure one or more personal activity metrics of the user 12. In some embodiments, the personal wearable device 18 may measure the heart rate, the blood pressure, and/or the body temperature of the corresponding user 12. As will be explained in further detail below, these measurements, sometimes referred to herein as personal activity quantifiers, may be provided to corresponding personal computing devices 16 intermittently, periodically, or upon request, through a corresponding PAN 24.

Continuing with FIG. 1, the business server computing device 22 is communicatively coupled to the LAN/WAN/Internet network 20 in order to provide one or more business activity performance metrics to the users 12. In particular, business activity performance metrics that the employer considers relevant to achieving a set business objective are measured, either subjectively or objectively, and stored in the business server computing device 22. As non-limiting examples, in a contact center scenario, the business activity performance metrics may include how many calls a user 12 has received, how many calls the user 12 has attended to successfully, how many calls the user 12 has failed to attend to successfully, or how much time the user 12 is spending per call. As will be explained in further detail below, these measurements, sometimes referred to herein as business activity performance quantifiers, may be provided to corresponding personal computing devices 16 intermittently, periodically, or upon request, through the LAN/WAN/Internet network 20, for example.

An example will now be described with regard to the user 12(i). The personal computing device 16(i) is communicatively coupled to the LAN/WAN/Internet network 20 and may only be accessed by the user 12(i) through, as non-limiting examples, a login name/password validation, biometric data validation (e.g., fingerprint, retina scan, etc.), or simply through physical possession. In some embodiments, the personal computing device 16(i) may be configured such that no authorization is necessary. As a non-limiting example, the user 12(i) may configure the personal computing device 16(i) to not verify the identity of the user 12(i) when the personal computing device 16(i) is kept in a controlled or otherwise secure area, such as the home of the user 12(i).

The personal computing device 16(i) includes an authorization module 26 configured to verify that the corresponding user 12(i) is authorized to access the personal computing device 16(i), business activity performance information, and/or personal activity information.

The personal computing device 16(i) further includes a business server computing device interface 28 for facilitating communications with the business server computing device 22. In one embodiment, the business server computing device interface 28 comprises an application programming interface (API). In some embodiments, the personal computing device 16(i) may receive authorization information for access to business activity performance quantifiers from the business server computing device 22. Such authorization information may be provided, for example, by the user 12(i). The personal computing device 16(i) transmits an access request message to the business server computing device 22 to request access to the business activity performance quantifiers. The access request message comprises the authorization information received from the user 12(i). The personal computing device 16(i) may receive a response message, in response to the access request message, from the business server computing device 22. The response message may indicate that the personal computing device 16(i) is authorized to receive access to the business activity performance quantifiers associated with the user 12(i).

In some embodiments, the authorization information may comprise a password or a biometric marker such as fingerprint information and/or retina information.

The personal computing device 16(i) further includes a wearable device interface 30 for facilitating communications with the personal wearable device 18(i). In one embodiment, the wearable device interface 30 may comprise an API. In some embodiments, the personal computing device 16(i) may receive authorization information from the user 12(i) for access to personal activity quantifiers generated by the wearable device interface 30. The personal computing device 16(i) determines that the authorization information authorizes access to the personal activity quantifiers. In some embodiments, the authorization information may comprise a password or a biometric marker such as fingerprint information and/or retina information.

The personal computing device 16(i) further includes a dashboard generation module 32 that uses received business activity performance quantifiers and personal activity quantifiers to generate a dashboard view including a visual representation of the received business activity performance quantifiers and personal activity quantifiers associated with a period of time.

The personal computing device 16(i) further includes a display device 34 for providing the dashboard view to the user 12(i). As non-limiting examples, the display device 34 may include a smartphone display if the personal computing device 16(i) comprises a smartphone or a computer tablet screen if the personal computing device 16(i) comprises a computer tablet.

The PAN 24 is a communication network for data transmission among devices such as, for example, personal computers, smartphones, computer tablets, and wearable devices. The PAN 24 may be a wired or wireless network. Non-limiting examples of PAN technology standards include Bluetooth™, Universal Serial Bus (USB), Infrared Data Association (IrDA), etc. The personal computing device 16(i) communicates with the corresponding personal wearable device 18(i) through a corresponding PAN. For example, the personal computing device 16(i) may receive personal activity quantifiers from the personal wearable device 18(i) through the PAN 24.

The personal wearable device 18(i) is communicatively coupled to the personal computing device 16(i) through the PAN 24. The personal wearable device 18(i) includes an authorization module 36 that is configured to verify that a user attempting to receive personal activity quantifiers from the personal wearable device 18(i) is authorized to do so. As noted above with respect to the personal computing device 16(i), authorization may be based on, as non-limiting examples, a login name/password validation or biometric data validation (e.g., fingerprint, retina scan, etc.). An authorization request may be provided directly to the personal wearable device 18(i) through a user interface (not shown) or via the personal computing device 16(i) and the PAN 24.

The personal wearable device 18(i) further includes a personal computing device interface 38 that provides an API for communicating with the personal computing device 16(i). The personal computing device interface 38 may receive personal activity quantifiers received from a personal activity module 40 and provide the personal activity quantifiers to the personal computing device 16(i) in response to a corresponding request for such personal activity quantifiers.

The personal wearable device 18(i) includes the personal activity module 40 in order to measure fitness and/or health metrics of the user 12(i) such as, for example, a heart rate, a blood pressure, and a body temperature. The personal activity module 40 includes at least one sensing device such as, for example, a motion sensor, an accelerometer, a pressure sensor, a thermometer, etc. to sense a related fitness and/or health metric of the user 12(i). The personal activity module 40 provides a value corresponding to the fitness, personal activity, and/or health metrics to the personal computing device interface 38 for transmission to the personal computing device 16(i).

The personal computing device 16(i) may receive business activity performance quantifiers of the user 12(i) from the business server computing device 22 and personal performance quantifiers of the user 12(i) from the corresponding personal wearable device 18(i), and present the same on the display device 34 relative to a particular period of time. The personal computing device 16(i) may also determine a correlation coefficient between the business activity performance quantifiers of the user 12(i) and the personal performance quantifiers of the user 12(i), and present the same on the display device 34 relative to a particular period of time. The embodiments allow the user 12(i) to, for example, assess if a relationship exists between the received business and personal performance quantifiers. As a result, the user 12(i) may modify a personal and/or a business activity in order to improve a corresponding personal and/or business activity performance.

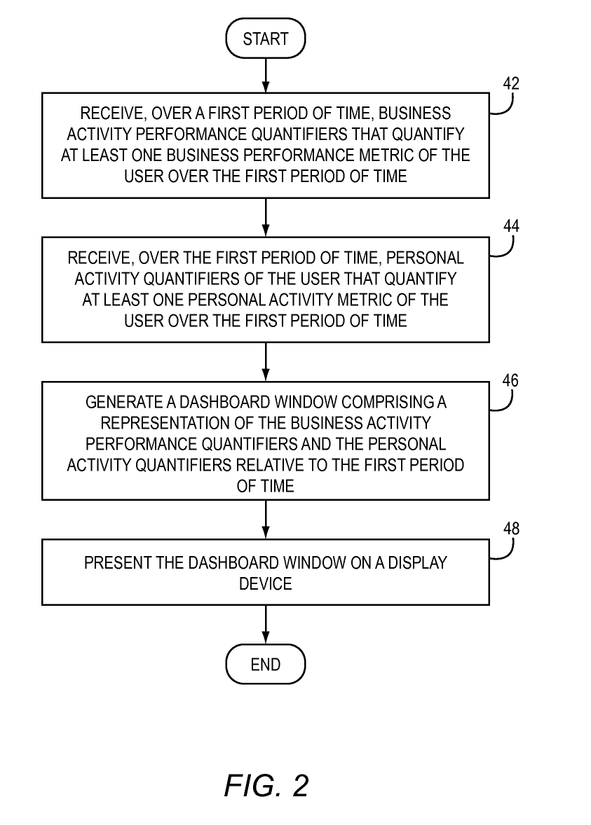

In this regard, FIG. 2 is a flowchart of a method for providing information to the user 12(i) according to one embodiment. FIG. 2 will be discussed in conjunction with FIG. 1. The personal computing device 16(i) receives, over a first period of time, business activity performance quantifiers that quantify at least one business activity performance metric of the user 12(i) (block 42). The personal computing device 16(i) then receives, over the first period of time, personal activity quantifiers of the user 12(i) that quantify at least one personal activity metric of the user 12(i) (block 44). Continuing with FIG. 2, the personal computing device 16(i) then generates a dashboard view comprising a visual representation of the received business activity performance quantifiers and the received personal activity quantifiers relative to the first period of time (block 46). The personal computing device 16(i) then presents the dashboard view on the display device 34 (block 48). In some embodiments, the personal computing device 16(i) may associate some of the business activity performance quantifiers with some of the personal activity quantifiers based on a particular period of time within the first period of time, and may depict those associated business activity performance quantifiers and personal activity quantifiers relative to the particular period of time. This allows the user 12(i) to, for example, track business activity performance metrics and personal activity metrics, relative to the first period of time, and determine if a relationship exists.

In some embodiments, the personal computing device 16(i) may determine a correlation coefficient between the business activity performance quantifiers and the personal activity quantifiers based on a particular period of time and depict the correlation coefficient during the particular period of time.

In some embodiments, the business activity performance quantifiers and the personal activity quantifiers may be associated with different periods of time. For example, a personal activity metric type corresponding to a personal activity that has a lasting effect on the user may affect a business activity performance metric of the user long after the time the personal activity quantifier corresponding to the personal activity metric type is measured. Accordingly, a personal activity metric type may have an associated “lag time” for which the personal computing device 16(i) may compensate when generating the dashboard view.

In that regard, in some embodiments, the personal computing device 16(i) may determine that some business activity performance quantifiers correspond to a particular period of time within a first period of time, determine a lag time for a personal activity metric corresponding to the personal activity quantifiers, subtract the lag time from the particular period of time to generate a lag-compensated period of time, and determine the personal activity quantifiers corresponding to the lag-compensated period of time. The personal computing device 16(i) may then generate a visual representation of the business activity performance quantifiers corresponding to the particular period of time, and of the personal activity quantifiers corresponding to the lag-compensated period of time. The personal computing device 16(i) may also determine a correlation coefficient between the business activity performance quantifiers corresponding to the particular period of time and the personal activity quantifiers corresponding to the lag-compensated period of time, and depict the correlation coefficient during the particular period of time. This would allow the user 12(i) to associate a business activity performance of a particular period of time with a personal activity that occurred during an earlier period of time.

In some embodiments, the process is iterative, such that the personal computing device 16(i) may associate activities that occur over multiple periods of time. The personal computing device 16(i) may receive, over a second period of time, second business activity performance quantifiers that quantify a business activity performance metric of the user 12(i) over the second period of time. The personal computing device 16(i) may also receive, over the second period of time, second personal activity quantifiers of the user 12(i) that quantify a personal activity metric of the user 12(i) over the second period of time. The personal computing device 16(i) may then update the dashboard view to include a visual representation of the second plurality of business activity performance quantifiers and the second plurality of personal activity quantifiers relative to the second period of time. The personal computing device 16(i) may then present the dashboard view on the display device 34.

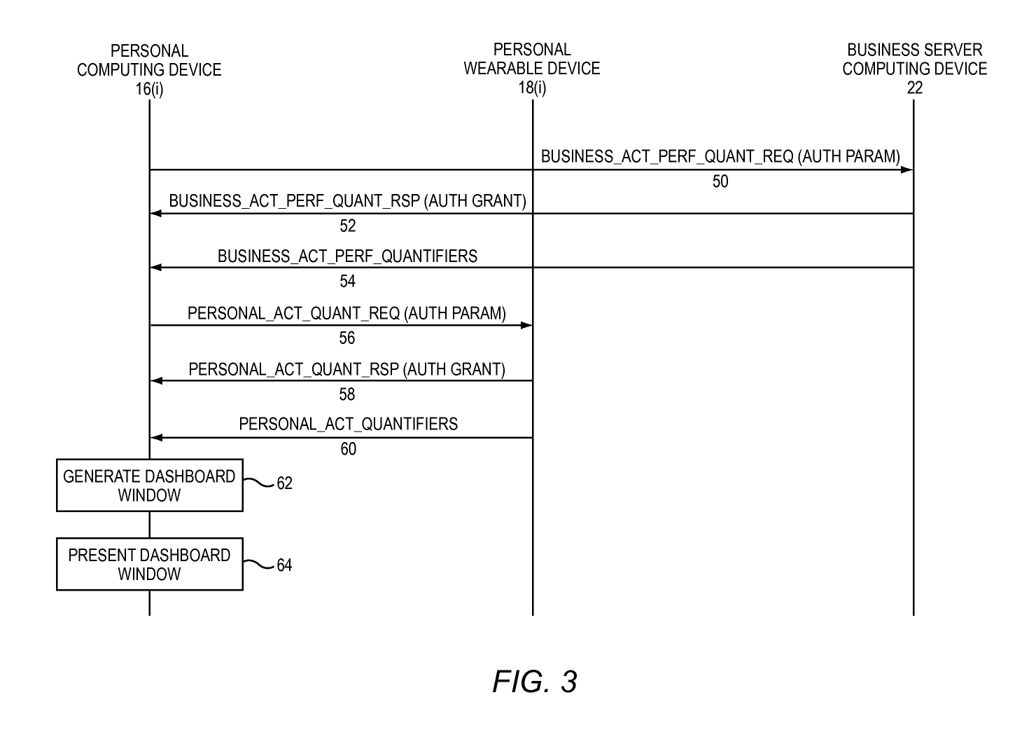

FIG. 3 is a message flow diagram illustrating an example flow of communications in the system 10 to provide information to a user 12(i) according to one embodiment. FIG. 3 will be discussed in conjunction with FIG. 1. The user 12(i) wishing to access a dashboard view including business activity performance quantifiers and personal activity quantifiers according to an embodiment provides authorization information to the personal computing device 16(i) and commands the personal computing device 16(i) to present the dashboard view.

In this regard, the personal computing device 16(i) sends message BUSINESS_ACT_PERF_QUANT_REQ, including authorization information, to the business server computing device 22 to request authorization to receive business activity performance quantifiers from the business server computing device 22 (step 50). In response, the business server computing device 22 sends message BUSINESS_ACT_PERF_QUANT_RSP, including an indication that the request has been granted (step 52). Furthermore, the business server computing device 22 sends message BUSINESS_ACT_PERF_QUANTIFIERS to the personal computing device 16(i) including the requested performance quantifiers (step 54).

The personal computing device 16(i) also sends message PERSONAL_ACT_QUANT_REQ, including authorization information, to the personal wearable device 18(i) (step 56). The authorization information may be the same authorization information sent by the personal computing device 16(i) to the business server computing device 22 in step 50, or may be different authorization information. In response, the personal wearable device 18(i) sends message PERSONAL_ACT_QUANT_RSP, including an indication that the request has been granted (step 58). Furthermore, the personal wearable device 18(i) sends message PERSONAL_ACT_QUANTIFIERS to the personal computing device 16(i) including the requested quantifiers (step 60).

The personal computing device 16(i) uses the business activity performance quantifiers received at step 54 and the personal activity quantifiers received at step 60 to generate a dashboard view (block 62) and presents the dashboard view to the user 12(i) via the display device 34 (block 64).

It is noted that the flow diagram of FIG. 3 is a non-limiting example of an embodiment, and the embodiments are not limited to the illustrated example flow. For example, in the illustrated example flow, the personal computing device 16(i) requests the business activity performance quantifiers from the business server computing device 22 before requesting the personal activity quantifiers from the personal wearable device 18(i). In some embodiments, however, the sequence for requesting activity quantifiers may be different. Furthermore, in the illustrated example flow, the business server computing device 22 provides to the personal computing device 16(i) a message to grant the request (step 52) and a separate message to provide the requested business activity performance quantifiers (step 54). In some embodiments, however, steps 52 and 54 may be combined in a single step/message. Further still, in the illustrated example flow, the personal computing device 16(i) sends a request for the personal activity quantifiers to the personal wearable device 18(i) and a request for the business activity performance quantifiers to the business server computing device 22. The personal computing device 16(i) then receives the personal activity quantifiers and the business activity performance quantifiers in response to the requests (steps 50-60). In some embodiments, however, the personal computing device 16(i) may receive the personal activity quantifiers from the personal wearable device 18(i) and/or the business activity performance quantifiers from the business server computing device 22 intermittently or periodically.

The business server computing device 22 and/or the personal wearable device 18(i) may provide their respective activity quantifiers intermittently or periodically, instead of in response to a request.

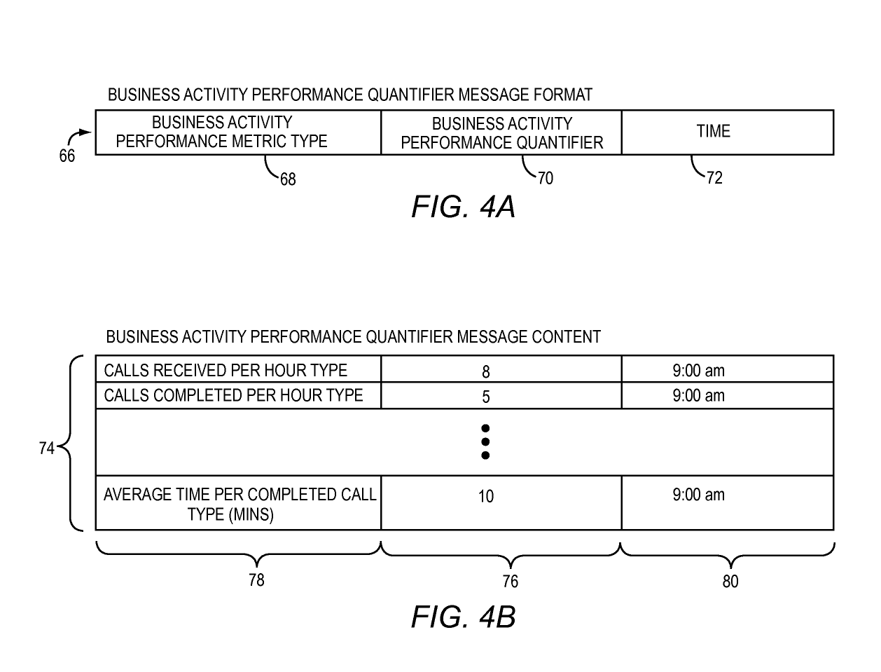

FIGS. 4A and 4B illustrate a non-limiting example of a format of a message from the business server computing device 22 to the personal computing device 16(i), such as the message of step 54 illustrated in FIG. 3. FIGS. 4A and 4B will be discussed in conjunction with FIGS. 1 and 3.

FIG. 4A illustrates a message format block 66 that includes a business activity performance metric type 68, such as, for example, how many calls the corresponding user has received during a predetermined period of time (e.g., calls received per hour). The message format block 66 further includes a business activity performance quantifier 70 corresponding to the business activity performance metric type 68 (e.g., 8, to indicate that 8 calls are being received per hour). The message format block 66 further includes a time 72 corresponding to a time when the corresponding business activity performance quantifier 70 was measured.

FIG. 4B illustrates the content of a message 74 including a plurality of message blocks in the format of message format block 66 illustrated in FIG. 4A. In particular, the message 74 includes a plurality of business activity performance quantifiers 76 corresponding to a plurality of business activity performance metric types 78. The message 74 further includes a plurality of times 80 corresponding to the plurality of business activity performance quantifiers 76.

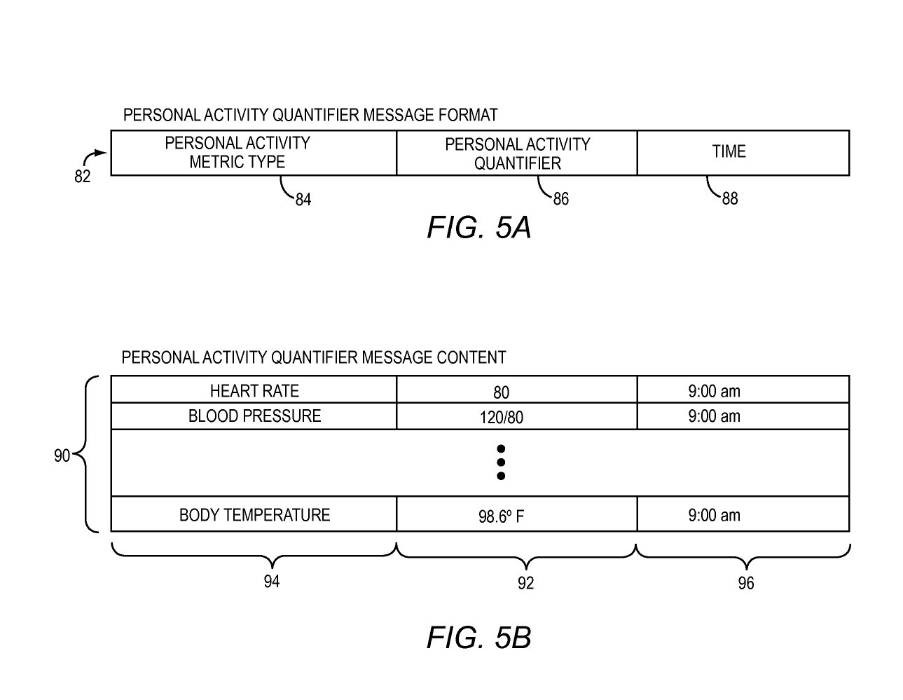

FIGS. 5A and 5B illustrate a non-limiting example of a format of a message from a personal wearable device 18 to a personal computing device 16, such as the message of step 60 illustrated in FIG. 3. FIGS. 5A and 5B will be discussed in conjunction with FIGS. 1 and 3.

FIG. 5A illustrates a message format block 82 that includes a personal activity metric type 84, such as, for example, a heart rate of a user during a predetermined period of time (e.g., heart beats per minute). The message format block 82 further includes a personal activity quantifier 86 corresponding to the personal activity metric type 84 (e.g., 80, to indicate 80 heart beats per minute). The message format block 82 further includes a time 88 corresponding to a time when the corresponding personal activity quantifier 86 was measured.

FIG. 5B illustrates the content of a message 90 including a plurality of message blocks in the format of message format block 82 illustrated in FIG. 5A. In particular, the message 90 includes a plurality of personal activity quantifiers 92 corresponding to a plurality of personal activity metric types 94.

The message 90 further includes a plurality of times 96 corresponding to the plurality of personal activity quantifiers 92.

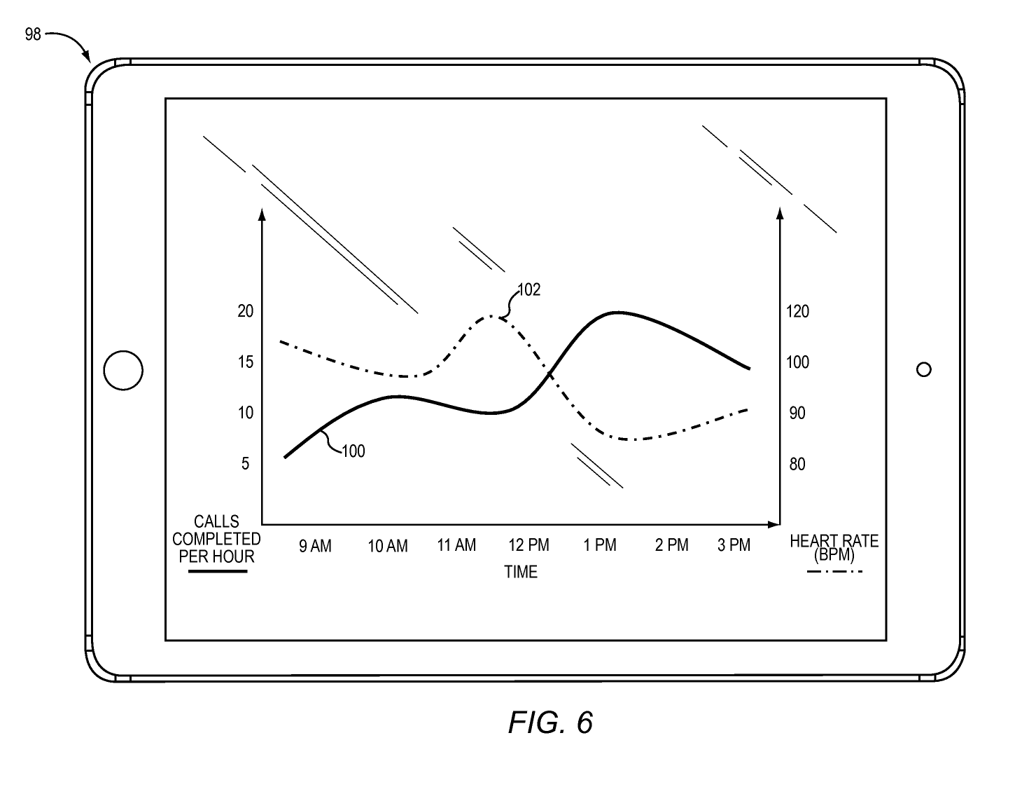

FIG. 6 illustrates a dashboard view 98 including a visual representation of a plurality of activity quantifiers for a business activity performance metric type and a personal activity metric type, relative to a period of time, according to one embodiment. In the visual representation, line 100 represents business activity performance quantifiers of the type “calls completed per hour,” relative to a time period between nine (9) am and three (3) pm. Line 102, on the other hand, represents personal activity performance quantifiers of the type “heart rate,” relative to the same time period (9 am to 3 pm).

In FIG. 6, as an example, a corresponding user 12 may gain insight from the visual representation and determine if there is a relationship between the visually represented activity types. For example, the user 12 may determine that an increase in heart rate that occurred between eleven (11) am and twelve (12) pm is related to a decrease in the rate of calls completed per hour during the same period of time (11 am to 12 pm).

As noted above, FIG. 6 illustrates a visual representation provided to a user 12 of business activity performance quantifiers and personal activity quantifiers relative to a period of time. However, the user 12 may not be able to, or may not be diligent in, reviewing the visual representation and, thus, may not adjust the business activity and/or a related personal activity accordingly.

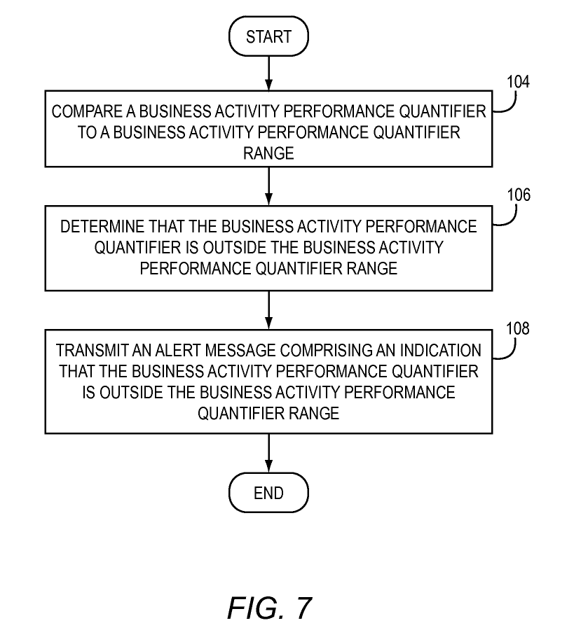

In that regard, FIG. 7 is a flowchart of a method for providing an alert to a user 12 when, for example, a business activity performance quantifier indicates a condition that may need immediate attention. FIG. 7 will be discussed in conjunction with FIG. 1. As a non-limiting example, the personal computing device 16(i) may determine, upon receiving a business activity performance quantifier, that the business activity performance of the user 12(i) is deviating from an acceptable level of performance. The acceptable level of performance may be set by the employer or the user 12(i). If the user 12(i) is not able to review a corresponding dashboard view, or forgets to do so, the personal computing device 16(i) sends an alert to, for example, the personal wearable device 18(i), to inform the user 12(i) of the performance deviation. The alert may include an audible alert, visual alert, or a physical alert.

The personal computing device 16(i) that has received a business activity performance quantifier from the business server computing device 22 compares the business activity performance quantifier to a business activity performance quantifier range corresponding to the business activity performance metric type of the business activity performance quantifier (block 104). The personal computing device 16(i) determines that the business activity performance quantifier is outside the business activity performance quantifier range (block 106) and transmits an alert message including an indication that the business activity performance quantifier is outside of the business activity performance quantifier range (block 108). In some embodiments, the personal computing device 16(i) transmits the alert message to the personal wearable device 18(i).

As a non-limiting example, for a business activity performance metric type of “calls completed per hour,” the user 12(i) may set a business activity performance range of more than ten (10), indicating that completing less than 10 calls per hour is below an acceptable level of performance. If the personal computing device 16(i) receives a business activity performance quantifier of 8 for the “calls completed per hour” business activity performance metric type, the personal computing device 16(i) will determine that the business activity performance quantifier is outside of the acceptable range. The personal computing device 16(i) will then send an alert to the personal wearable device 18(i) to alert the user 12(i) of the performance deviation.

In some embodiments, the personal computing device 16(i) may also determine a correlation coefficient between received business activity performance quantifiers corresponding to a particular period of time and received personal activity quantifiers corresponding to the particular period of time. The personal computing device 16(i) may compare the correlation coefficient to a correlation coefficient range of the user 12(i) corresponding to a business activity performance metric of the business activity performance metric type, and determine that the correlation coefficient is inside the correlation coefficient range. The personal computing device 16(i) will then send an alert to the personal wearable device 18(i) to alert the user 12(i) that the correlation coefficient is inside the correlation coefficient range.

In some embodiments, the personal computing device 16(i) may also store the indication that the correlation coefficient is inside the correlation coefficient range in association with the business activity performance metric and at least some personal activity quantifiers. The personal computing device 16(i) may also determine that a number of stored indications in association with the business activity performance metric and the at least some personal activity quantifiers is greater than a correlation indication threshold. The personal computing device 16(i) may then transmit a correlation message comprising an indication that the number of stored indications in association with the business activity performance metric and the at least some personal activity quantifiers is greater than the correlation indication threshold. The correlation message may be transmitted to, for example, the business server computer device 22, such that the employer/business entity may gain insight into personal activities that may positively correlate with business activity performance.

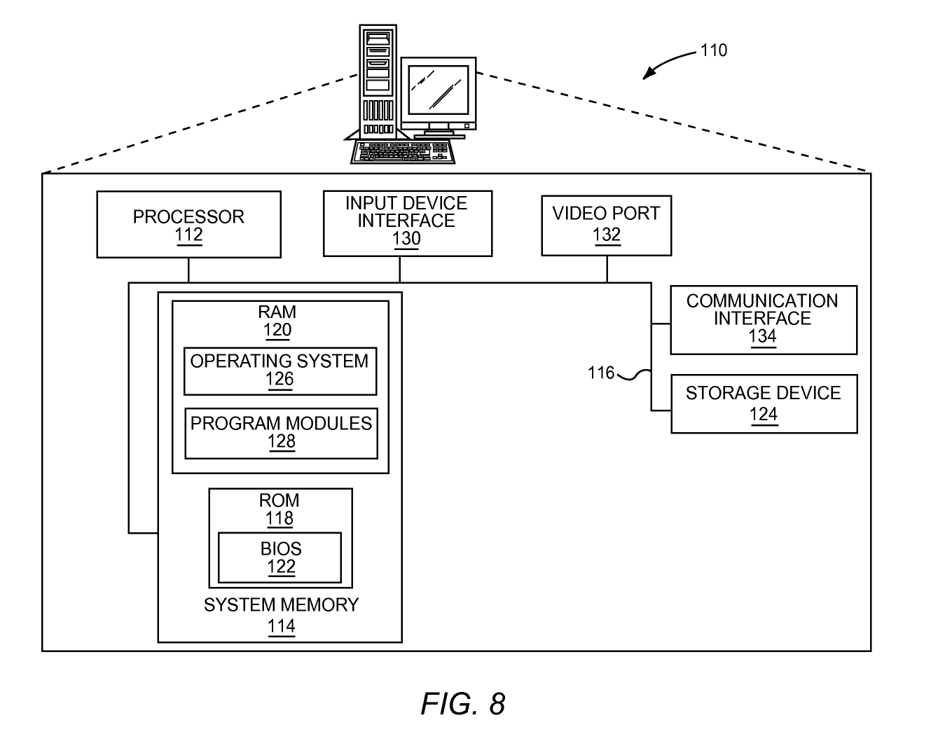

FIG. 8 is a block diagram of an exemplary computing device 110 in which embodiments disclosed herein may be implemented. The computing device 110 may comprise, for example: a laptop computer, a desktop computer, a personal digital assistant (PDA), a workstation, a server, or any other computing device comprising a processor and capable of processing both data and suitable instructions to carry out the functionality described herein. The computing device 110 may include a processor, such as a processor 112, a system memory 114, and a system bus 116. The system bus 116 provides an interface for system components including, but not limited to, the system memory 114 and the processor 112. The processor 112 can be any of various commercially available or proprietary processors. Dual microprocessors and other multi-processor architectures may also be employed as the processor 112.

The system bus 116 may be any of several types of bus structures that may further interconnect to a memory bus (with or without a memory controller), a peripheral bus, and/or a local bus using any of a variety of commercially available bus architectures. The system memory 114 may include non-volatile memory 118 (e.g., read only memory (ROM), erasable programmable read only memory (EPROM), electrically erasable programmable read only memory (EEPROM), etc.) and/or volatile memory 120 (e.g., random access memory (RAM)). A basic input/output system (BIOS) 122 may be stored in the non-volatile memory 118, and can include the basic routines that help to transfer information between elements within the computing device 110. The volatile memory 120 may also include a high-speed RAM, such as static RAM, for caching data.

The computing device 110 may further include a storage device 124, which may comprise, for example, an internal hard disk drive (HDD) (e.g., enhanced integrated drive electronics (EIDE) or serial advanced technology attachment (SATA)) for storage, flash memory, or the like. The storage device 124 and associated computer-readable and computer-usable media provide non-volatile storage of data, data structures, computer-executable instructions, and so forth, such as the personal computing device 16(i) illustrated in FIG. 1 and described above. Although the description of computer-readable media above refers to an HDD, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of program modules can be stored in the storage device 124 and in the volatile memory 120, including an operating system 126 and one or more program modules 128, which may implement the functionality described herein in whole or in part, including, for example, functionality associated with the personal computing device 16(i) illustrated in FIG. 1 and described above. It is to be appreciated that the embodiments can be implemented with various commercially available operating systems 126 or combinations of operating systems 126.

All or a portion of the embodiments may be implemented as a computer program product, such as a non-transitory computer-usable or computer-readable medium having a computer-readable program code embodied therein. The computer-readable program code can include complex software instructions for implementing the functionality of the embodiments described herein when executed on the processor 112. The processor 112, in conjunction with the program modules 128 in the volatile memory 120, may serve as a controller, or control system, for the computing device 110 that is configured to, or adapted to, implement the functionality described herein.

An administrator may be able to enter commands and information into the computing device 110 through one or more input devices, such as, for example, a touch-sensitive display (not illustrated), a keyboard (not illustrated), or a pointing device, such as a mouse (not illustrated). Other input devices (not illustrated) may include a microphone, an infrared (IR) remote control, a joystick, a game pad, a stylus pen, or the like. These and other input devices are often connected to the processor 112 through an input device interface 130 that is coupled to the system bus 116, but can be connected by other interfaces such as a parallel port, an IEEE 1394 serial port, a game port, a universal serial bus (USB) port, an IR interface, etc.

The computing device 110 may drive a separate or integral display device (not shown), which may also be connected to the system bus 116 via an interface, such as a video port 132. The computing device 110 preferably includes a communication interface 134 that is configured to communicate with a network, such as the LAN/WAN/Internet network 20 and the PAN 24 illustrated in FIG. 1.

Those skilled in the art will recognize improvements and modifications to the preferred embodiments of the disclosure. All such improvements and modifications are considered within the scope of the concepts disclosed herein and the claims that follow.

What is claimed is:

1. A method for providing information to a user, comprising:
receiving, over a first period of time by a personal computing device, a first plurality of business activity performance quantifiers that quantify at least one business activity performance metric of the user over the first period of time;
receiving, over the first period of time by the personal computing device, a first plurality of personal activity quantifiers of the user that quantify at least one personal activity metric of the user over the first period of time;
generating, by the personal computing device, a dashboard view comprising a visual representation of the first plurality of business activity performance quantifiers and the first plurality of personal activity quantifiers relative to the first period of time; and
presenting, by the personal computing device, the dashboard view on a display device.

2. The method of claim 1, further comprising associating at least some business activity performance quantifiers of the first plurality of business activity performance quantifiers with at least some personal activity quantifiers of the first plurality of personal activity quantifiers based on a particular period of time within the first period of time,
wherein the visual representation of the first plurality of business activity performance quantifiers and the first plurality of personal activity quantifiers depicts the at least some business activity performance quantifiers and the at least some personal activity quantifiers being associated with the particular period of time.

3. The method of claim 2, wherein associating the at least some business activity performance quantifiers with the at least some personal activity quantifiers based on the particular period of time within the first period of time comprises:
determining the at least some business activity performance quantifiers corresponding to the particular period of time;
determining a lag time for a personal activity metric corresponding to the at least some personal activity quantifiers;
subtracting the lag time from the particular period of time to generate a lag-compensated period of time within the first period of time;
determining the at least some personal activity quantifiers corresponding to the lag-compensated period of time; and
generating a visual representation of the at least some business activity performance quantifiers corresponding to the particular period of time, and of the at least some personal activity quantifiers corresponding to the lag-compensated period of time.

4. The method of claim 2, further comprising:
comparing the at least some business activity performance quantifiers to a business activity performance quantifier range of the user corresponding to a business activity performance metric of the at least one business activity performance metric;
determining that the at least some business activity performance quantifiers are outside the business activity performance quantifier range; and
transmitting an alert message comprising an indication that the at least some business activity performance quantifiers are outside the business activity performance quantifier range.

5. The method of claim 4, wherein transmitting the alert message comprises transmitting the alert message to a wearable device that is worn by the user.

6. The method of claim 1, further comprising determining a correlation coefficient between at least some business activity performance quantifiers of the first plurality of business activity performance quantifiers and at least some personal activity quantifiers of the first plurality of personal activity quantifiers based on a particular period of time within the first period of time,
wherein the visual representation of the first plurality of business activity performance quantifiers and the first plurality of personal activity quantifiers depicts the correlation coefficient between the at least some business activity performance quantifiers and the at least some personal activity quantifiers during the particular period of time.

7. The method of claim 6, wherein determining the correlation coefficient between the at least some business activity performance quantifiers and the at least some personal activity quantifiers based on the particular period of time within the first period of time comprises:
determining the at least some business activity performance quantifiers corresponding to the particular period of time;
determining a lag time for a personal activity metric corresponding to the at least some personal activity quantifiers;
subtracting the lag time from the particular period of time to generate a lag-compensated period of time;
determining the at least some personal activity quantifiers corresponding to the lag-compensated period of time;
determining the correlation coefficient between the at least some business activity performance quantifiers of the first plurality of business activity performance quantifiers during the particular period of time and the at least some personal activity quantifiers of the first plurality of personal activity quantifiers during the lag-compensated period of time; and
generating a visual representation of the correlation coefficient relative to the particular period of time.

8. The method of claim 6, further comprising:
comparing the correlation coefficient to a correlation coefficient range of the user corresponding to a business activity performance metric of the at least one business activity performance metric;
determining that the correlation coefficient is inside the correlation coefficient range; and
transmitting an alert message comprising an indication that the correlation coefficient is inside the correlation coefficient range.

9. The method of claim 8, further comprising:
storing the indication that the correlation coefficient is inside the correlation coefficient range in association with the business activity performance metric and the at least some personal activity quantifiers;
determining that a number of stored indications in association with the business activity performance metric and the at least some personal activity quantifiers is greater than a correlation indication threshold; and
transmitting a correlation message comprising an indication that the number of stored indications in association with the business activity performance metric and the at least some personal activity quantifiers is greater than the correlation indication threshold.

10. The method of claim 8, wherein transmitting the alert message comprises transmitting the alert message to a wearable device that is worn by the user.

11. The method of claim 1, further comprising:
receiving authorization information for access to the first plurality of personal activity quantifiers; and
determining that the authorization information authorizes access to the first plurality of personal activity quantifiers.

12. The method of claim 1, further comprising:
receiving authorization information for access to the first plurality of business activity performance quantifiers;
transmitting an access request message to a business server computing device to request access to the first plurality of business activity performance quantifiers, the access request message comprising the authorization information; and
receiving a response message in response to the access request message, the response message indicating that the personal computing device is authorized to receive access to the first plurality of business activity performance quantifiers.

13. The method of claim 12, wherein the authorization information comprises at least one of a password and a biometric marker.

14. The method of claim 1, further comprising:
receiving authorization information for access to the first plurality of business activity performance quantifiers;
providing, to an application programming interface (API) of the personal computing device, the authorization information, wherein the API is configured to transmit an access request message to a business server computing device to request access to the first plurality of business activity performance quantifiers; and
receiving a response message in response to the access request message, the response message indicating that the personal computing device is authorized to receive access to the first plurality of business activity performance quantifiers.

15. The method of claim 1, wherein receiving the first plurality of personal activity quantifiers comprises receiving the first plurality of personal activity quantifiers in one of an intermittent manner, a periodic manner, and upon request from a wearable device that is worn by the user.

16. The method of claim 1, wherein receiving the first plurality of personal activity quantifiers comprises receiving the first plurality of personal activity quantifiers from a wearable device that is owned by the user.

17. The method of claim 1, wherein the personal computing device is exclusively accessed by the user.

18. The method of claim 1, wherein the at least one business activity performance metric comprises at least one of calls received per hour, calls completed per hour, and average time per completed call,
wherein the at least one personal activity metric comprises at least one of a heart rate, a blood pressure, and a body temperature.

19. The method of claim 1, further comprising:
receiving, over a second period of time, a second plurality of business activity performance quantifiers that quantify at least one business activity performance metric of the user over the second period of time;
receiving, over the second period of time, a second plurality of personal activity quantifiers of the user that quantify at least one personal activity metric of the user over the second period of time;
updating the dashboard view, comprising including in the dashboard view a visual representation of the second plurality of business activity performance quantifiers and the second plurality of personal activity quantifiers relative to the second period of time; and
presenting, by the personal computing device, the dashboard view on the display device.

20. A computer device comprising:
a communication interface configured to communicate with a network; and
a processor, coupled to the communication interface, configured to:
receive, over a first period of time, a first plurality of business activity performance quantifiers that quantify at least one business activity performance metric of the user over the first period of time;
receive, over the first period of time, a first plurality of personal activity quantifiers of the user that quantify at least one personal activity metric of the user over the first period of time;
generate a dashboard view comprising a visual representation of the first plurality of business activity performance quantifiers and the first plurality of personal activity quantifiers relative to the first period of time; and
present the dashboard view on a display device.

21. A computer program product for providing information to a user, the computer program product stored on a non-transitory computer-readable storage medium and including instructions configured to cause a processor to carry out the steps of:
receiving, over a first period of time, a first plurality of business activity performance quantifiers that quantify at least one business activity performance metric of the user over the first period of time;
receiving, over the first period of time, a first plurality of personal activity quantifiers of the user that quantify at least one personal activity metric of the user over the first period of time;
generating a dashboard view comprising a visual representation of the first plurality of business activity performance quantifiers and the first plurality of personal activity quantifiers relative to the first period of time; and
presenting the dashboard view on a display device.
